(19) United States
(12) Patent Application Publication
(10) Pub. No.: US 2013/0260761 A1
(43) Pub. Date: Oct. 3, 2013

(54) METHOD AND APPARATUS FOR SUPPORTING TUNE AWAY IN DUAL-SIM DUAL STANDBY MOBILE DEVICES

(71) Applicant: QUALCOMM INCORPORATED, San Diego, CA (US)

(72) Inventors: Simon James WALKE, Kempshott (GB); Nicholas John TEBBIT, Old Windsor (GB); Venkata Raji Reddy KANTHALA, Hyderabad (IN)

(73) Assignee: QUALCOMM INCORPORATED, San Diego, CA (US)

(21) Appl. No.: 13/831,773

(22) Filed: Mar. 15, 2013

Related U.S. Application Data
(60) Provisional application No. 61/618,201, filed on Mar. 30, 2012.

(51) Int. Cl. H04W 36/00

(52) U.S. Cl. CPC H04W 36/00
USPC 455/436

(57) ABSTRACT

The present disclosure presents methods and apparatuses for improved tune away in dual-SIM, dual-standby user equipment (UE) in a wireless environment. For example, in an aspect, the present disclosure presents a method of improving active calls in a wireless environment, which may include establishing an active call on a first subscription associated with a first subscriber identification module (SIM) in a multi-standby user UE. In an additional aspect, such example methods may include limiting one or more idle mode procedures of a second subscription associated with a second SIM in the multi-standby UE to non-critical idle mode procedures. Furthermore, in some examples, the one or more idle mode procedures may include cell reselection procedures.

### CLAIM OF PRIORITY UNDER 35 U.S.C. §119

The present application for patent claims priority to Provisional Application No. 61/618,201 entitled “Method and Apparatus for Supporting Tune Away in DSDS Mobile Devices” filed Mar. 30, 2012, and assigned to the assignee hereof and hereby expressly incorporated by reference herein.

### BACKGROUND

1. Field

Aspects of the present disclosure relate generally to wireless communication systems, and more particularly, to tune away in Dual-SIM Dual-Standby (DSDS) devices.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

Additionally, some wireless devices are configured to facilitate communication on two separate networks via two separate subscriptions. For instance, dual-Subscriber Identity Module (SIM), dual standby (DSDS) user equipment (UE) and/or devices may include two SIM cards—one card for a first subscription and a second card for a second subscription. In DSDS devices, a user may engage in a data call on a first of the two subscriptions and the second of the two subscriptions may remain in idle mode. While in idle mode, the second subscription may receive idle mode control messages from the second subscription provider network. Specifically, the DSDS device may support tune away functionality, whereby when the user is communicating with a network via a first subscription, the mobile device will continue to monitor the second subscription and will tune away from the first subscription periodically to receive control messages, such as a page indication, via the second subscription.

Monitoring the idle-mode second subscription, however, can have negative performance effects on the ongoing data call of the first subscription. Furthermore, one a cell reselection has occurred on the second subscription, the second subscription may also be required to perform uplink signaling, which, if performed, would further degrade the active call on the first subscription. Therefore, where idle mode procedures on the second subscription become significant, the active call on the first subscription may be significantly degraded or completely dropped due to the limited resources available on the device radio.

Thus, a method and apparatus for improving idle mode tune away selection in DSDS devices is needed.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, the present disclosure presents a method of improving active calls in a wireless environment, which may include establishing an active call on a first subscription associated with a first SIM in a multi-standby. Furthermore, such an example method may include limiting one or more idle mode procedures of a second subscription associated with a second SIM in the multi-standby UE to non-critical idle mode procedures, which may include cell reselection procedures.

In an additional aspect, the present disclosure presents an apparatus for improving active calls in a wireless environment, which may include means for establishing an active call on a first subscription associated with a first SIM in a multi-standby UE. Additionally, such an example apparatus may include means for limiting one or more idle mode procedures of a second subscription associated with a second SIM in the multi-standby UE to non-critical idle mode procedures, which may be cell reselection procedures.

In yet an additional aspect, the present disclosure presents a computer-readable medium comprising machine-executable code for establishing an active call on a first subscription associated with a first SIM in a multi-standby UE. Additionally, the computer-readable medium may include machine-executable code for limiting one or more idle mode procedures of a second subscription associated with a second SIM in the multi-standby UE to non-critical idle mode procedures, which may include cell reselection procedures.

Moreover, the present disclosure presents an example apparatus for supporting tune away, which may include at least one processor and a memory coupled to the at least one processor, where the at least one processor may be configured to establish an active call on a first subscription associated with a first SIM in a multi-standby UE. In addition, the at least one processor may be configured to limit one or more idle mode procedures of a second subscription associated with a second SIM in the multi-standby UE to non-critical idle mode procedures, which may include cell reselection procedures.

These and other aspects of the disclosure will become more fully understood upon a review of the detailed description, which follows.

### BRIEF DESCRIPTION OF THE DRAWINGS

FIG. 1 is a block diagram illustrating an example wireless system of aspects of the present disclosure;

FIG. 2 is a block diagram illustrating an example of a computer device in aspects of the present disclosure;

FIG. 3 is a flow diagram illustrating aspects of a method for supporting limited idle mode processes in a multi-standby UE as provided by the present disclosure;

FIG. 4 is a component diagram illustrating aspects of a logical grouping of electrical components as contemplated by the present disclosure;

FIG. 5 is a block diagram illustrating an example of a hardware implementation for an apparatus employing a processing system;

FIG. 6 is a block diagram conceptually illustrating an example of a telecommunications system;

FIG. 7 is a conceptual diagram illustrating an example of an access network;

FIG. 8 is a conceptual diagram illustrating an example of a radio protocol architecture for the user and control plane; and

FIG. 9 is a block diagram conceptually illustrating an example of a Node B in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The present disclosure provides methods and apparatuses for supporting improved selective tune away in a multi-standby user equipment (UE). For example, according to some aspects of the present disclosure, the UE may establish an active call via a first subscription, which may be ongoing. While the first subscription is engaged in the ongoing call, the UE may need to perform idle mode procedures, such as cell reselection processes, for a second subscription that is in idle mode. According to the present disclosure, these idle mode procedures may be limited from legacy idle mode procedures to lessen the possibility of significant idle mode procedures affecting the quality of the ongoing call on the first subscription. In some aspects, the idle mode procedures may be limited by altering existing cell reselection processes. For example, in legacy reselection processes, a UE may engage in continual pilot monitoring to search for a “better” cell than its current cell with which to connect via a handover procedure. More specifically, in this legacy cell reselection procedure, the UE may initiate a handover to this “better” cell any time the pilot strength associated with this “better” cell is greater than its serving cell pilot strength.

According to the present disclosure, however, this legacy procedure may be altered to limit the constant monitoring and reselection procedures, which may consume significant resources on the radio and degrade the ongoing active call from the first subscription. For example, in an aspect, the UE may limit cell reselection to exclude “non-essential” processes. According to the present disclosure, non-essential processes may include those processes associated with cell reselection to the legacy processes' “better” cell. Instead, the UE of the present disclosure may only perform cell reselection procedures where a current serving cell cannot sustain service to the UE. In other aspects, the UE may apply additional hysteresis to existing idle mode process algorithms to artificially render surrounding cells less attractive for handover purposes. Furthermore, the UE may manage timer-based calculations to defer cell reselection processes for the idle mode second subscription to lessen their impact on an ongoing active call on a first subscription. For example, in an aspect, the UE may extend or otherwise alter one or more timers, which may include one or more reselection timer, and may perform at least one reselection procedure when one or more of the at least one reselection timer expires.

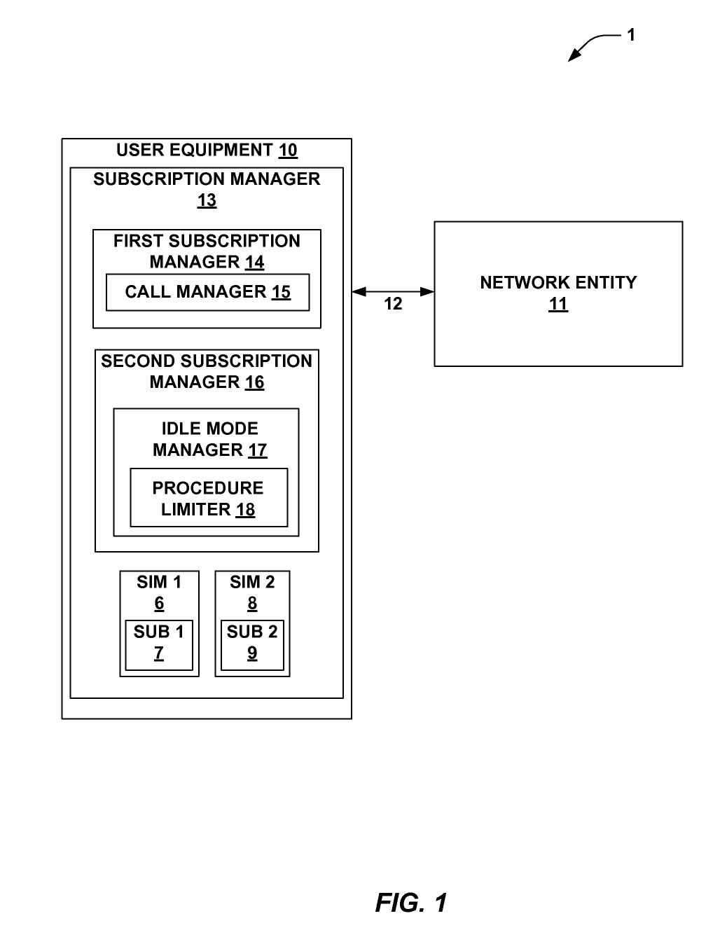

Referring to FIG. 1, a wireless communication system 1 is illustrated that enables power savings in one or more UEs. System 1 includes a UE 10 that communicates with one or more network entities 11 to receive wireless network access. Network entity 11 may include one or more of any type of network component, such as an access point, including a base station (BS) or node B, a relay, a peer-to-peer device, a radio network controller (RNC), an authentication, authorization and accounting (AAA) server, a mobile switching center (MSC), etc., that can enable UE 10 to communicate and/or that can establish and maintain a communication link 12. In addition, UE 10 may be a multi-SIM, multi-standby device, such as a dual-SIM, dual standby (DSDS) device.

Furthermore, UE 10 may include a subscription manager 13, which may be configured to manage one or more subscription technology types in UE 10. Additionally, in an aspect, subscription manager 13 may include a first subscription manager 14, which may be configured to manage the processes associated with a first subscription. These processes may include receiving and transmitting signals associated with an ongoing data call, which may include a voice call, SMS message, or any other communication between the first subscription and a network entity 11. In an aspect, first subscription manager 14 may include a call manager 15, which may be configured to establish and engage in an active call with another device via network entity 11.

In addition, UE 10 may include a second subscription manager 16, which may be configured to manage a second subscription on UE 10. In an aspect, second subscription manager 16 may include an idle mode manager 17, which may direct and/or perform idle mode procedures associated with a second subscription 9. For example, idle mode manager 17 may perform cell reselection procedures, and may do so in conjunction with one or more communication components that may monitor one or more pilot signals associated with neighboring cells and/or the cell currently serving the second subscription. Furthermore, idle mode manager 17 may include a procedure limiter 18, which may be configured to limit idle mode procedures associated with the second subscription. For example, idle mode manager 17 may be configured to alter legacy cell reselection algorithms or processes to limit idle mode procedures associated with the second subscription. For example, in an aspect, the idle mode manager 17 (e.g. via procedure limiter 18) may extend or otherwise alter one or more timers, which may include one or more reselection timer. Further, the UE may perform at least one reselection procedure when one or more of the at least one reselection timer expires. Thus, because the one or more reselection timer may have been extended (or otherwise altered) by idle mode manager 17, the reselection procedures may thus be limited in frequency, thus limiting this idle mode procedure.

Additionally, subscription manager may include two or more subscriber identification modules (SIM), such as a first SIM 6 and a second SIM 8. In an aspect, each SIM may be associated with a subscription, such as, but not limited to a first subscription 7 associated with the first SIM 6 and/or a second subscription 9 associated with the second SIM 8. In some aspects, however, UE 10 may include more than two SIMs.

In an additional aspect, wireless system 1 may include one or more network entities 11, which may be configured to provide services to UE 10 according to one or more technologies associated with a first subscription and/or a second subscription.

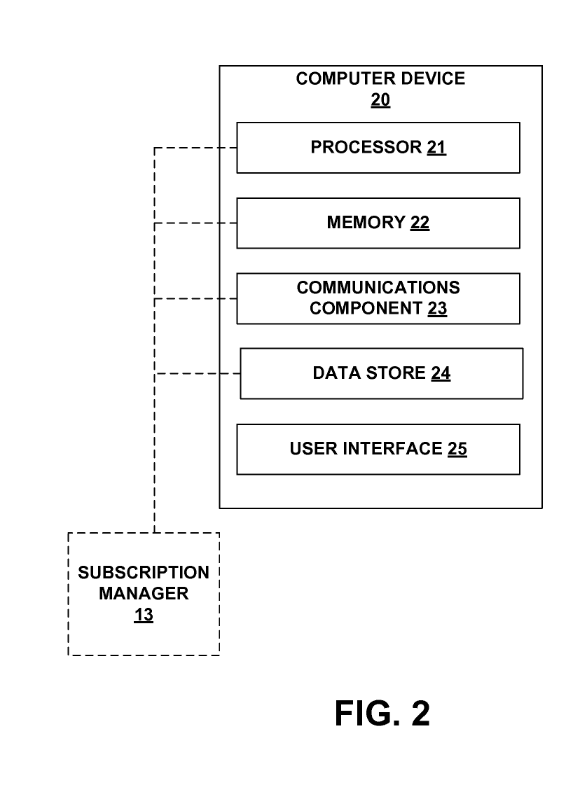

Referring to FIG. 2, in one aspect, any of UE 10, or the one or more network entities 11 (FIG. 1) may be represented by a specially programmed or configured computer device 20. Computer device 20 includes a processor 21 for carrying out processing functions associated with one or more of components and functions described herein. Processor 21 can include a single or multiple set of processors or multi-core processors. Moreover, processor 21 can be implemented as an integrated processing system and/or a distributed processing system.

Computer device 20 further includes a memory 22, such as for storing data used herein and/or local versions of applications being executed by processor 21. Memory 22 can include any type of memory usable by a computer, such as random access memory (RAM), read only memory (ROM), tapes, magnetic discs, optical discs, volatile memory, non-volatile memory, and any combination thereof.

Further, computer device 20 includes a communications component 23 that provides for establishing and maintaining communications with one or more parties utilizing hardware, software, and services as described herein. Communications component 23 may carry communications between components on computer device 20, as well as between computer device 20 and external devices, such as devices located across a communications network and/or devices serially or locally connected to computer device 20. For example, communications component 23 may include one or more buses, and may further include transmit chain components and receive chain components associated with a transmitter and receiver, respectively, or a transceiver, operable for interfacing with external devices. In an additional aspect, communications component 23 may be configured to receive one or more pages from one or more subscriber networks. In a further aspect, such a page may correspond to the second subscription and may be received via the first technology type communication services.

Additionally, computer device 20 may further include a data store 24, which can be any suitable combination of hardware and/or software, that provides for mass storage of information, databases, and programs employed in connection with aspects described herein. For example, data store 24 may be a data repository for applications not currently being executed by processor 21.

Computer device 20 may additionally include a user interface component 25 operable to receive inputs from a user of computer device 20, and further operable to generate outputs for presentation to the user. User interface component 25 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 25 may include one or more output devices, including but not limited to a display, a speaker, a haptic feedback mechanism, a printer, any other mechanism capable of presenting an output to a user, or any combination thereof. In an additional aspect, a user using the user interface 25 may set one of a first subscription or a second subscription as a dedicated data service (DDS) for the computer device 20.

In a mobile station implementation, such as for UE 10 of FIG. 1, computer device 20 may include subscription manager 13, such as in specially programmed computer readable instructions or code, firmware, hardware, or some combination thereof.

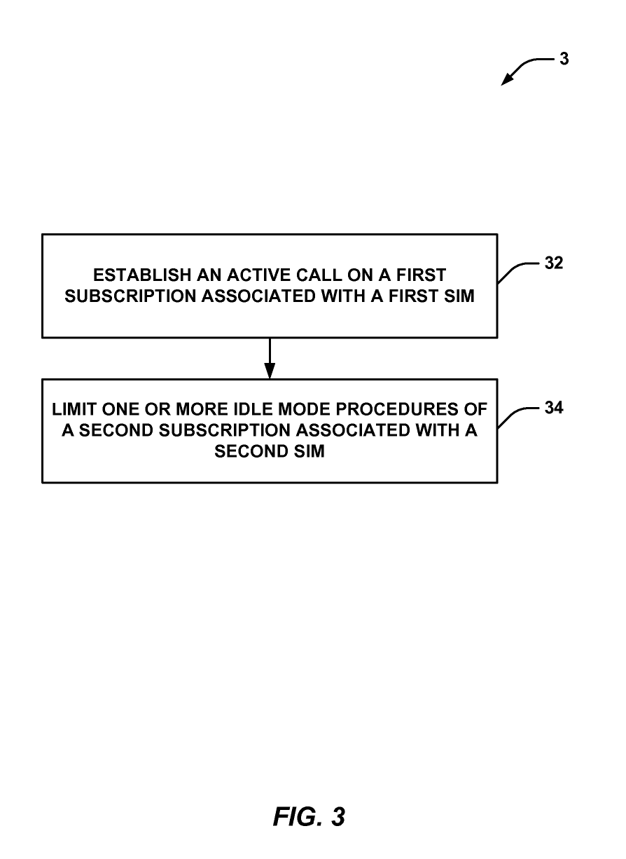

Referring to FIG. 3, an example methodology for improved idle mode procedures in a UE is provided. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

In an aspect, at block 32, a subscription managing component or other UE component (e.g. subscription manager 13 and/or call manager 15 of UE 10, FIGS. 1 and 2) may establish, at block 32, an active call on a first subscription associated with a first SIM. In an aspect, the active call may be a voice call, a data call or session, and/or a messaging call, or any other active communication with a network entity. Furthermore, at block 34, the subscription managing component or other UE component (e.g. procedure limiter 18 of FIG. 1) may limit one or more idle mode procedures of a second subscription associated with a second SIM. For example, in so limiting the idle mode procedures, the UE may limit cell reselection procedures typically performed by a UE searching for a “better” cell with which to communicate. More specifically, in this legacy cell reselection procedure, the UE may have initiated a handover to this “better” cell any time the pilot strength associated with this “better” cell is greater than its serving cell pilot strength.

According to the present disclosure, however, this legacy procedure may be altered to limit the constant monitoring and reselection procedures, which may consume significant resources on the radio and degrade the ongoing active call from the first subscription. For example, in an aspect, a UE component (e.g. procedure limiter 18 and/or subscription manager 13 of UE 10 of FIG. 1) may limit cell reselection to exclude “non-essential” processes. According to the present disclosure, non-essential processes may include those processes associated with cell reselection to the legacy processes' “better” cell. Instead, the UE of the present disclosure may only perform cell reselection procedures where a current serving cell cannot sustain service to the UE. For example, according to aspects of the present disclosure, non-critical idle mode procedures may comprise GSM C2 reselection procedures.

In other aspects, to limit the one or more idle processes according to block 34, the UE may apply additional hysteresis to existing idle mode process algorithms to artificially render surrounding cells less attractive for handover purposes. For example, the UE may alter pilot signal measurement values associated with neighbor signals or otherwise alter the characteristics of a neighbor cell that may make that neighbor cell a viable option for handover in legacy idle mode cell reselection processes. Furthermore, the UE may manage timer-based calculations to defer cell reselection processes for the idle mode second subscription to lessen their impact on an ongoing active call on a first subscription. In an aspect, for example, the UE may maintain a reselection timer, which may govern when a subscription in idle mode is permitted to search for cells for reselection.

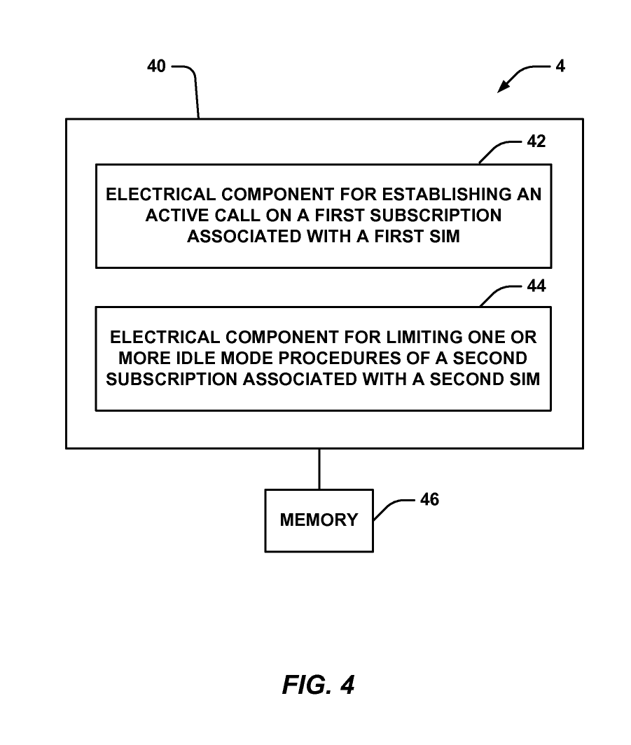

Referring to FIG. 4, an example system 4 is displayed for limiting idle mode procedures in a subscription in a multi-standby UE. For example, system 4 can reside at least partially within one or more network entities. It is to be appreciated that system 4 is represented as including functional blocks, which can be functional blocks that represent functions implemented by a processor, software, or combination thereof (e.g., firmware). System 4 includes a logical grouping 40 of electrical components that can act in conjunction. For instance, logical grouping 40 can include an electrical component 42 for establishing an active call on a first subscription associated with a first SIM. In an aspect, electrical component 42 may comprise call manager 15 (FIG. 1) and/or processor 21 (FIG. 2). In an additional aspect, logical grouping 40 can include an electrical component 44 for limiting one or more idle mode procedures of a second subscription associated with a second SIM. In an aspect, electrical component 44 may comprise procedure limiter 18 (FIG. 1) and/or processor 21 (FIG. 2).

Additionally, system 4 can include a memory 46 that retains instructions for executing functions associated with the electrical components 42 and 44, stores data used or obtained by the electrical components 42 and 44, etc. While shown as being external to memory 46, it is to be understood that one or more of the electrical components 42 and 44 can exist within memory 46. In one example, electrical components 42 and 44 can comprise at least one processor, or each electrical component 42 and 44 can be a corresponding module of at least one processor. Moreover, in an additional or alternative example, electrical components 42 and 44 can be a computer program product including a computer readable medium, where each electrical component 42 and 44 can be corresponding code.

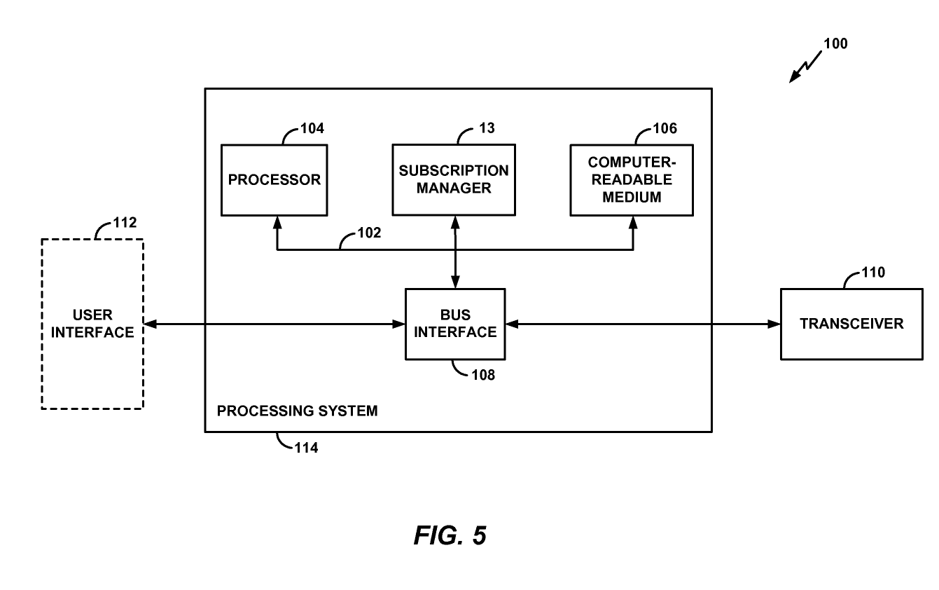

FIG. 5 is a block diagram illustrating an example of a hardware implementation for an apparatus 100 employing a processing system 114. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. Additionally, as indicated in FIG. 5, bus 102 may link subscription manager (e.g. subscription manager 13 of FIGS. 1 and 2) to bus interface 108 and/or other components in a UE implementation of processing system 114, such as, but not limited to, UE 10 of FIG. 1. For example, in some aspects, processing system 114 may comprise UE 10 of FIG. 1, wherein the processing system 114 may execute the functions of subscription manager 13 described above, such as, but not limited to, with processor 104 executing instructions stored on computer-readable medium 106 and defining the functions of subscription manager 13.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

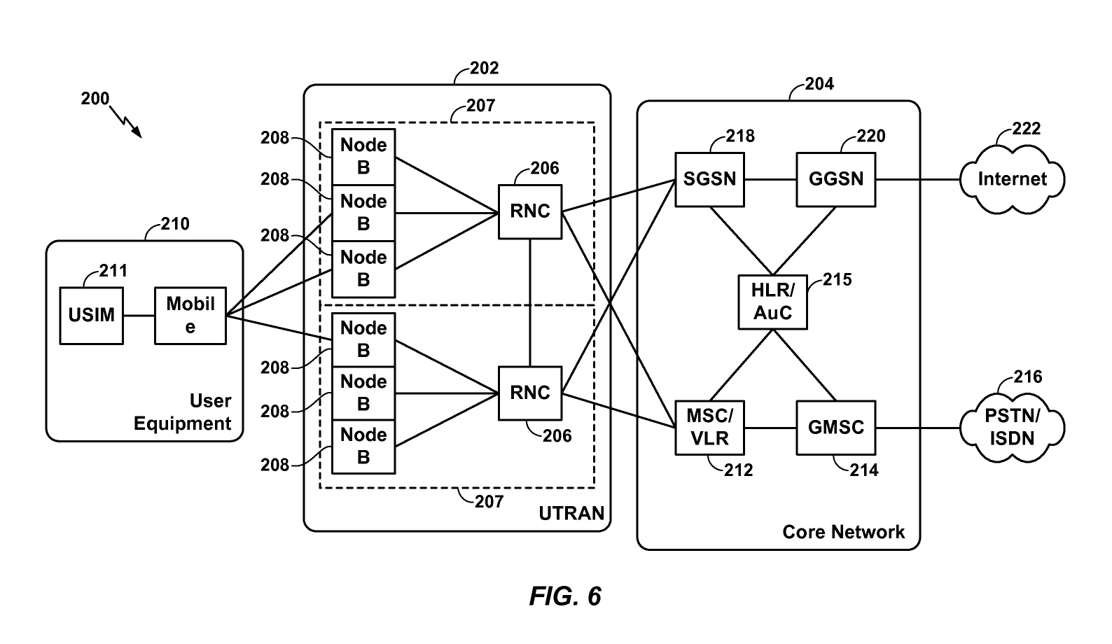

The various concepts presented throughout this disclosure may be implemented across a broad variety of telecommunication systems, network architectures, and communication standards. By way of example and without limitation, the aspects of the present disclosure illustrated in FIG. 6 are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210. In an aspect, UE 210 may be UE 10 (FIG. 1), and UMTS 202 may comprise network entity 11 (FIG. 11). In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring, and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, incorporated herein by reference.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a CN 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 210 provides feedback to the node B 208 over the HS-DPCCH to indicate whether it correctly decoded a packet on the downlink.

HS-DPCCH further includes feedback signaling from the UE 210 to assist the node B 208 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 208 and/or the UE 210 may have multiple antennas supporting MIMO technology. The use of MIMO technology enables the node B 208 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams destined for that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

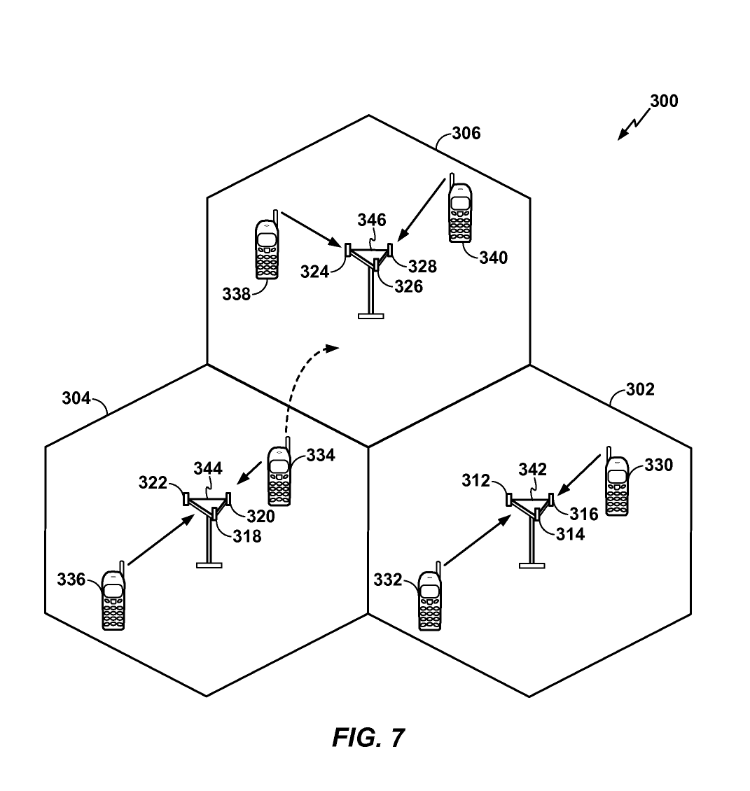

Referring to FIG. 7, an access network 300 in a UTRAN architecture is illustrated. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 (see FIG. 6) for all the UEs 330, 332, 334, 336, 338, 340 in the respective cells 302, 304, and 306.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 6), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

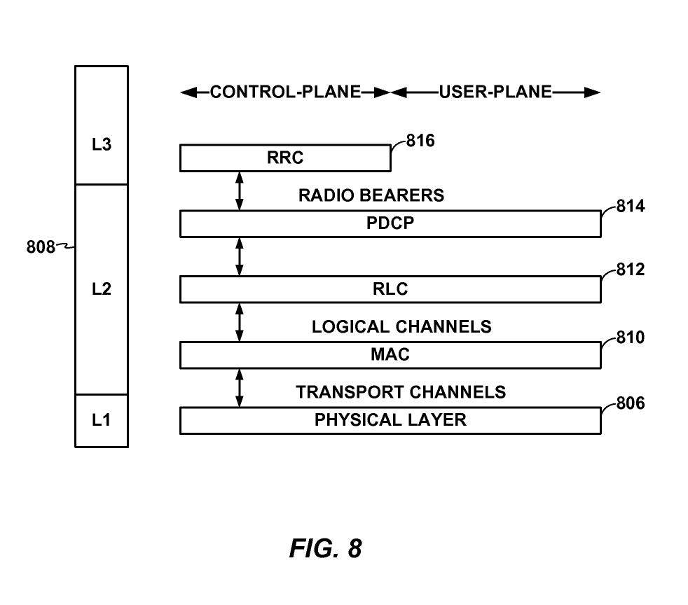

The radio protocol architecture may take on various forms depending on the particular application. An example for an HSPA system will now be presented with reference to FIG. 8. FIG. 8 is a conceptual diagram illustrating an example of the radio protocol architecture for the user and control planes.

Turning to FIG. 8, the radio protocol architecture for the UE and node B is shown with three layers: Layer 1, Layer 2, and Layer 3. Layer 1 is the lowest lower and implements various physical layer signal processing functions. Layer 1 will be referred to herein as the physical layer 406. Layer 2 (L2 layer) 408 is above the physical layer 406 and is responsible for the link between the UE and node B over the physical layer 406.

In the user plane, the L2 layer 408 includes a media access control (MAC) sublayer 410, a radio link control (RLC) sublayer 412, and a packet data convergence protocol (PDCP) 414 sublayer, which are terminated at the node B on the network side. Although not shown, the UE may have several upper layers above the L2 layer 408 including a network layer (e.g., IP layer) that is terminated at a PDN gateway on the network side, and an application layer that is terminated at the other end of the connection (e.g., far end UE, server, etc.).

The PDCP sublayer 414 provides multiplexing between different radio bearers and logical channels. The PDCP sublayer 414 also provides header compression for upper layer data packets to reduce radio transmission overhead, security by ciphering the data packets, and handover support for UEs between node Bs. The RLC sublayer 412 provides segmentation and reassembly of upper layer data packets, retransmission of lost data packets, and reordering of data packets to compensate for out-of-order reception due to hybrid automatic repeat request (HARQ). The MAC sublayer 410 provides multiplexing between logical and transport channels. The MAC sublayer 410 is also responsible for allocating the various radio resources (e.g., resource blocks) in one cell among the UEs. The MAC sublayer 410 is also responsible for HARQ operations.

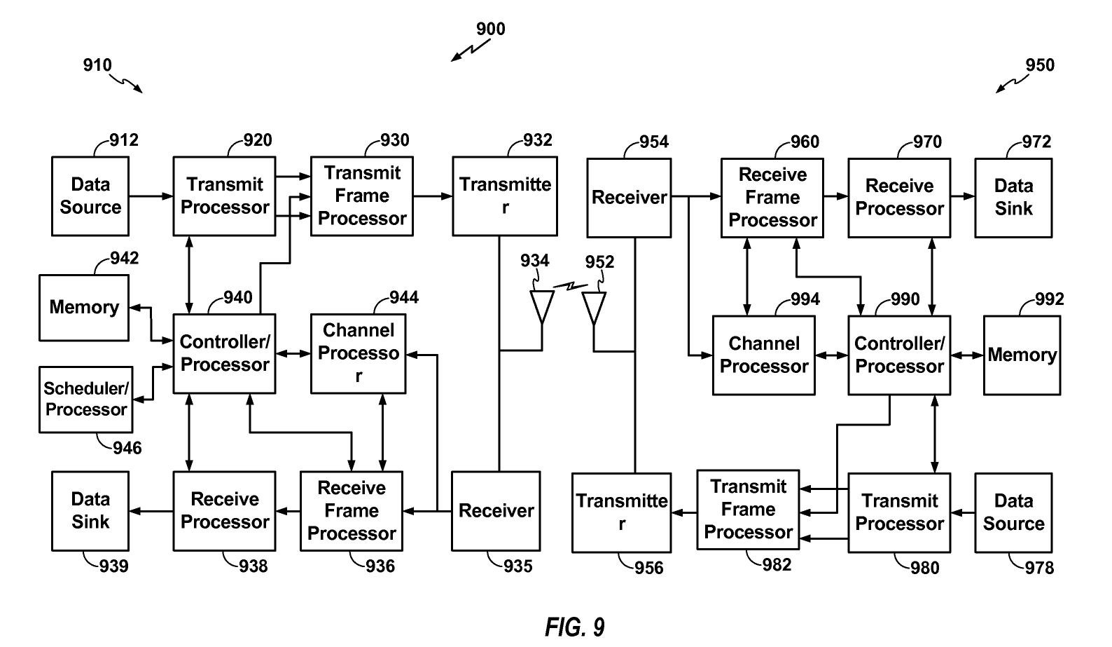

FIG. 9 is a block diagram of a Node B 510 in communication with a UE 550, where the Node B 510 may be the Node B 208 in FIG. 6, and the UE 550 may be the UE 210 in FIG. 6. In the downlink communication, a transmit processor 520 may receive data from a data source 512 and control signals from a controller/processor 540. The transmit processor 520 provides various signal processing functions for the data and control signals, as well as reference signals (e.g., pilot signals). For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by a controller/processor 540 to determine the coding, modulation, spreading, and/or scrambling schemes for the transmit processor 520. These channel estimates may be derived from a reference signal transmitted by the UE 550 or from feedback from the UE 550. The symbols generated by the transmit processor 520 are provided to a transmit frame processor 530 to create a frame structure. The transmit frame processor 530 creates this frame structure by multiplexing the symbols with information from the controller/processor 540, resulting in a series of frames. The frames are then provided to a transmitter 532, which provides various signal conditioning functions including amplifying, filtering, and modulating the frames onto a carrier for downlink transmission over the wireless medium through antenna 534. The antenna 534 may include one or more antennas, for example, including beam steering bidirectional adaptive antenna arrays or other similar beam technologies.

At the UE 550, a receiver 554 receives the downlink transmission through an antenna 552 and processes the transmission to recover the information modulated onto the carrier. The information recovered by the receiver 554 is provided to a receive frame processor 560, which parses each frame, and provides information from the frames to a channel processor 594 and the data, control, and reference signals to a receive processor 570. The receive processor 570 then performs the inverse of the processing performed by the transmit processor 520 in the Node B 510. More specifically, the receive processor 570 descrambles and despreads the symbols, and then determines the most likely signal constellation points transmitted by the Node B 510 based on the modulation scheme. These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 550 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 and control signals from the controller/processor 590 are provided to a transmit processor 580. The data source 578 may represent applications running in the UE 550 and various user interfaces (e.g., keyboard). Similar to the functionality described in connection with the downlink transmission by the Node B 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the Node B 510 or from feedback contained in the midamble transmitted by the Node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with information from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the Node B 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which parses each frame, and provides information from the frames to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor, the controller/processor 540 may also use an acknowledgement (ACK) and/or negative acknowledgement (NACK) protocol to support retransmission requests for those frames.

The controller/processors 540 and 590 may be used to direct the operation at the Node B 510 and the UE 550, respectively. For example, the controller/processors 540 and 590 may provide various functions including timing, peripheral interfaces, voltage regulation, power management, and other control functions. The computer readable media of memories 542 and 592 may store data and software for the Node B 510 and the UE 550, respectively. A scheduler/processor 546 at the Node B 510 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of improving active calls in a wireless environment, comprising:
establishing an active call on a first subscription associated with a first subscriber identification module (SIM) in a multi-standby user equipment (UE); and
limiting one or more idle mode procedures of a second subscription associated with a second SIM in the multi-standby UE to non-critical idle mode procedures.

2. The method of claim 1, wherein the one or more idle mode procedures comprise cell reselection procedures.

3. The method of claim 2, wherein the non-critical idle mode procedures comprise cell reselection procedures occurring where a current cell is able to sustain service to the UE.

4. The method of claim 1, wherein the limiting comprises altering at least one existing reselection algorithm to limit the one or more idle mode procedures.

5. The method of claim 1, wherein the limiting comprises altering one or more timers.

6. The method of claim 1, wherein the altering one or more timers comprises extending at least one reselection timer, and further comprising performing at least one reselection procedure when one or more of the at least one reselection timer expires.

7. The method of claim 1, wherein the non-critical idle mode procedures comprise Global System for Mobile Communications (GSM) C2 reselection procedures.

8. An apparatus for improving active calls in a wireless environment, comprising:
means for establishing an active call on a first subscription associated with a first subscriber identification module (SIM) in a multi-standby user equipment (UE); and
means for limiting one or more idle mode procedures of a second subscription associated with a second SIM in the multi-standby UE to non-critical idle mode procedures.

9. The apparatus of claim 8, wherein the one or more idle mode procedures comprise cell reselection procedures.

10. The apparatus of claim 9, wherein the non-critical idle mode procedures comprise cell reselection procedures occurring where a current cell is able to sustain service to the UE.

11. The apparatus of claim 8, wherein the means for limiting comprises means for altering at least one existing reselection algorithm to limit the one or more idle mode procedures.

12. The apparatus of claim 8, wherein the means for limiting comprises means for altering one or more timers.

13. The apparatus of claim 12, wherein the means for altering one or more timers comprises means for extending at least one reselection timer, and further comprising means for performing at least one reselection procedure when one or more of the at least one reselection timer expires.

14. The apparatus of claim 8, wherein the non-critical idle mode procedures comprise Global System for Mobile Communications (GSM) C2 reselection procedures.

15. A computer program product, comprising a computer-readable medium comprising machine-executable code for:
establishing an active call on a first subscription associated with a first subscriber identification module (SIM) in a multi-standby user equipment (UE); and
limiting one or more idle mode procedures of a second subscription associated with a second SIM in the multi-standby UE to non-critical idle mode procedures.

16. The computer program product of claim 15, wherein the one or more idle mode procedures comprise cell reselection procedures.

17. The computer program product of claim 16, wherein the non-critical idle mode procedures comprise cell reselection procedures occurring where a current cell is able to sustain service to the UE.

18. The computer program product of claim 15, wherein the code for limiting comprises code for altering at least one existing reselection algorithm to limit the one or more idle mode procedures.

19. The computer program product of claim 15, wherein the code for limiting comprises code for altering one or more timers.

20. The computer program product of claim 19, wherein the code for altering one or more timers comprises code for extending at least one reselection timer, and wherein the computer-readable medium further comprises machine-executable code for performing at least one reselection procedure when one or more of the at least one reselection timer expires.

21. The computer-readable medium of claim 15, wherein the non-critical idle mode procedures comprise Global System for Mobile Communications (GSM) C2 reselection procedures.

22. An apparatus for supporting tune away, comprising:
at least one processor; and
a memory coupled to the at least one processor, wherein the at least one processor is configured to:
establish an active call on a first subscription associated with a first subscriber identification module (SIM) in a multi-standby user equipment (UE); and
limit one or more idle mode procedures of a second subscription associated with a second SIM in the multi-standby UE to non-critical idle mode procedures.

23. The apparatus of claim 22, wherein the one or more idle mode procedures comprise cell reselection procedures.

24. The apparatus of claim 23, wherein the non-critical idle mode procedures comprise cell reselection procedures occurring where a current cell is able to sustain service to the UE.

25. The apparatus of claim 22, wherein the limiting comprises altering at least one existing reselection algorithm to limit the one or more idle mode procedures.

26. The apparatus of claim 22, wherein the limiting comprises altering one or more timers.

27. The apparatus of claim 26, wherein the altering one or more timers comprises extending at least one reselection timer, and wherein the at least one processor is configured to perform at least one reselection procedure when one or more of the at least one reselection timer expires.

28. The apparatus of claim 22, wherein the non-critical idle mode procedures comprise Global System for Mobile Communications (GSM) C2 reselection procedures.
